(19) United States
(12) Patent Application Publication
(10) Pub. No.: US 2020/0097931 A1
(43) Pub. Date: Mar. 26, 2020

(54) PAYMENT TRANSACTION PROCESS EMPLOYING INVOICE TOKEN

(71) Applicant: MASTERCARD INTERNATIONAL INCORPORATED, Purchase, NY (US)

(72) Inventors: Yen Tran, Darien, CT (US); Sandeep Malhotra, Greenwich, CT (US); Mostafa Hussein Sabet, Greenwich, CT (US); Shanthan Subramaniam, Baldwin Place, NY (US)

(21) Appl. No.: 16/138,646

(22) Filed: Sep. 21, 2018

(51) Int. Cl. G06Q 20/10; G06Q 20/32; G06Q 20/36

(52) U.S. Cl. CPC G06Q 20/102; G06Q 20/3674; G06Q 20/3223

(57) ABSTRACT

A method includes receiving an invoice token from a merchant, where the invoice token represents an invoice for an e-commerce transaction. The invoice token is transmitted to a payment services computer to request details of the invoice. The requested invoice details are received from the payment service computer, and an account is selected to support payment for the transaction. A payment transaction is initiated to settle the e-commerce transaction based on the invoice details and the account that was selected to support the payment.

### BACKGROUND

FIG. 1 is a block diagram that illustrates a conventional payment system 100.

The system 100 includes a customer device 102 by which a user 103 accesses an e-commerce server 104 via the internet 105. The customer device 102 may be any type of computing device usable to allow access to the internet, and runs a browser program (not separately shown) to enable interaction between the customer device 102 and the various resources available via the internet. The customer device 102 may be, for example, a personal computer, a laptop computer, a tablet computer or a mobile-browser-equipped smartphone or other mobile device. The e-commerce server 104 is typically a server computer operated by or on behalf of a merchant to host an online store/shopping website and to allow virtual visits to the website from customer devices. The e-commerce server 104 also operates to handle online-shopping transactions, typically funded by a payment system account owned by the user 103. In an online shopping transaction, the user 103 operates the customer device 102 to select one or more items for purchase, then elects to enter a checkout phase of the transaction, in which information that identifies the user's payment system account is provided to or accessed by the e-commerce server 104.

A computer 108 operated by an acquirer (acquiring financial institution) is also shown as part of the system 100 in FIG. 1. The acquirer may be a financial institution that provides payment account acceptance services to the merchant that operates the e-commerce server 104. The acquirer computer 108 may operate to receive a transaction authorization request message (“authorization request”) for the online shopping transaction from the e-commerce server 104. The acquirer computer 108 may route the authorization request via a payment network 110 (sometimes also referred to as a “card network”) to the server computer 112 operated by the issuer of the payment account that was specified during the checkout phase of the online shopping transaction. A transaction authorization response message (“authorization response”) generated by the payment account issuer server computer 112 may be routed back to the e-commerce server 104 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users and/or other entities. For example, the payment account issuer server computer 112 may perform such functions as (a) receiving and responding to requests for authorization of payment account transactions to be charged to payment accounts issued by the FI; (b) engaging in payment transaction clearing operations; and (c) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their e-commerce servers. The system may also include a very large number of payment account holders, who engage in online shopping transactions.

As is well known to those who are skilled in the art, a typical payment system like that shown in FIG. 1 may also handle numerous face to face purchase transactions at the point of sale in retail stores and other establishments. In a typical such transaction (not illustrated), the customer may present a payment card or other payment-enabled device (e.g., a payment-enabled mobile device) to a point of sale (POS) terminal. The POS terminal is operated by the merchant (or merchant's employee) to read payment account information from the card or device presented by the customer. An authorization request may originate from the POS terminal for routing to the account issuer, and the authorization response may be routed back to the POS terminal from the account issuer.

In some e-commerce transactions, the user enters the PAN (primary account number) for his/her payment card account during the checkout phase of interaction between the customer device and the e-commerce server. In other arrangements, there may be a “card-on-file” with the e-commerce server, so that the user does not have to enter his/her PAN.

One concern that arises in connection with many e-commerce arrangements is whether the user's account information may be at risk of being compromised while in the possession of the merchant.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a payment system provided according to aspects of the present disclosure.

FIG. 3 is a block diagram that illustrates a computer system that may perform a role in the system of FIG. 2.

FIG. 4 is a simplified block diagram of a customer device that may perform a role in the system of FIG. 2.

FIGS. 5A and 5B together form a flow chart that illustrates a process that may be performed in the system of FIG. 2 according to aspects of the present disclosure.

### DETAILED DESCRIPTION

In general, and for the purpose of introducing concepts of embodiments of the present disclosure, as part of an e-commerce transaction, the merchant may supply invoice details for the transaction to a trusted remote payment services computer. The payment services computer may store the invoice details and generate an alphanumeric string to serve as an invoice token that represents the stored invoice details. The payment services computer may transmit the invoice token to the merchant, which may in turn provide the invoice token to the customer device that is engaged in the e-commerce transaction. A payment app in the customer device may transmit the invoice token to the remote trusted payment services computer, thereby requesting a download of the invoice details to the customer device. Upon receipt of the invoice details, the payment app may initiate a payment transaction via interaction with the customer's payment account issuer (i.e., the customer's bank). The payment transaction request from the payment app to the account issuer may be based on the invoice details. The account issuer may perform a “credit” payment network transaction to push the transaction amount for the e-commerce transaction to the merchant's bank account at the merchant's bank. Alternatively, an ACH (automated clearing house) transaction may be initiated via the customer's bank, charging a deposit account that the customer's bank maintains for the customer. Suitable confirmations/notifications may be sent to the customer, to the merchant and to the payment services computer, thereby completing the checkout phase of the e-commerce transaction.

With this approach to the checkout phase, the security of the customer's sensitive financial account information is enhanced in that such information is communicated only from the customer to his/her bank and through transaction processing channels, and not to the merchant. Consequently, the customer's account information is not subject to compromise in the event of a data breach affecting the merchant's data processing systems.

Moreover, suitable safeguards may be established between the payment services computer and the merchants participating in the payment system such that the merchant's identity and bona fides may be established to the satisfaction of the payment services computer in connection with the merchant's uploading of invoice details and request for the invoice token. As a result, the customer can be assured that the invoice details he/she receives from the payment services computer are indicative of a valid merchant and valid merchant banking details, thereby reducing or eliminating any risk relating to the validity of the e-commerce website with which the customer was interacting. In other words, the customer is assured that he/she is dealing with a reputable merchant.

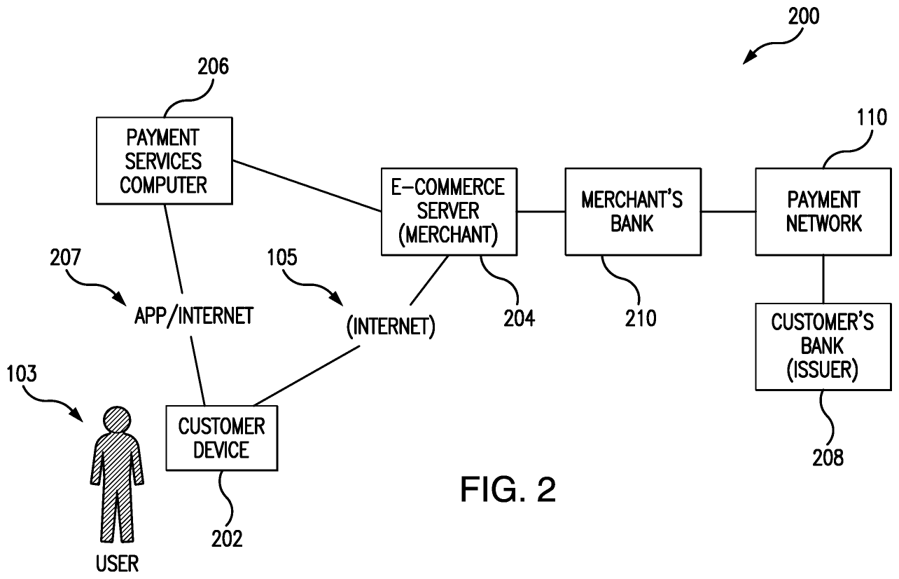

FIG. 2 is a block diagram that illustrates a payment system 200 provided according to aspects of the present disclosure.

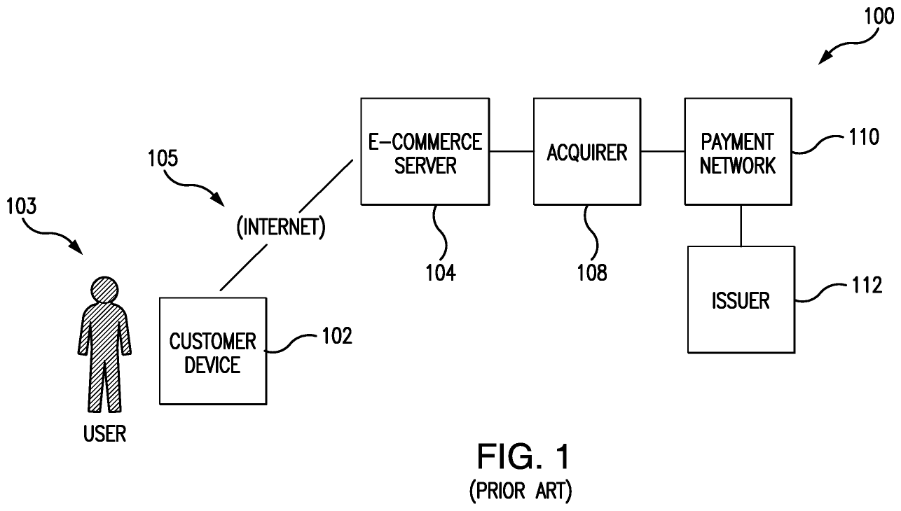

As in the system of FIG. 1, a user 103 is shown operating a customer device 202, so as to interact with an e-commerce server 204 via the internet 105. As before, the e-commerce server 204 is operated by or on behalf of a merchant, which is not indicated in the drawing apart from the e-commerce server. In accordance with aspects of the present disclosure, the system 200 further includes a payment services computer 206. Some of the functionality provided by the payment services computer has been sketched out above; further details of operation of the payment services computer 206 will be provided below. Operation of the payment system 200 includes interactions between the payment services computer 206 and (a) the e-commerce server 204 and (b) the customer device 202. The interactions between the customer device 202 and the payment services computer 206 may occur via in-application (“in-app”) or internet communication 207.

Other components of the payment system 200 include the aforementioned payment network 110, the customer's bank 208 and the merchant's bank 210.

In some embodiments, the payment services computer 206 may be under common operation with the payment network 110.

As was the case with the system as depicted in FIG. 1, FIG. 2 only shows components required for handling a single transaction. In a practical embodiment of the system 200, there may be numerous e-commerce servers, and customer devices, a large number of merchants' and customers' banks, and potentially also a number of payment service computers. The system 200 may also handle transactions at the point of sale, and so may include many items of POS equipment like those referred to above. Still further, the system 200 may include a very large number of customer payment devices, such as cards, fobs, payment-enabled mobile devices, etc., for use in initiating transactions at the point of sale.

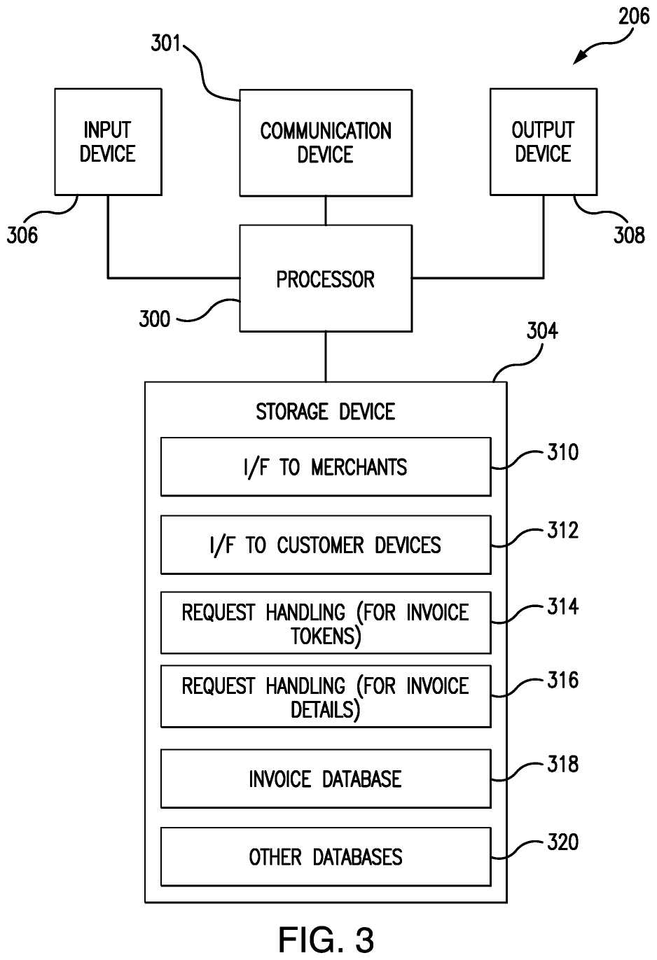

FIG. 3 is a block diagram that illustrates an embodiment of the payment services computer 206 shown in FIG. 2.

Referring now to FIG. 3, the payment services computer 206 may, in its hardware aspects, resemble a typical server computer and/or mainframe computer, but may be controlled by software to cause it to function as described herein. For example, the payment services computer 206 may be constituted by commercially available server computer hardware and/or by cloud-based computing resources.

The payment services computer 206 may include a computer processor 300 operatively coupled to a communication device 301, a storage device 304, an input device 306 and an output device 308. The communications device 301, the storage device 304, the input device 306 and the output device 308 may all be in communication with the processor 300.

The computer processor 300 may be constituted by one or more conventional processors. Processor 300 operates to execute processor-executable steps, contained in program instructions described below, so as to control the payment services computer 206 to provide desired functionality.

Communication device 301 may be used to facilitate communication with, for example, other devices (such as customer devices and merchants' e-commerce servers). For example, communication device 301 may comprise numerous communication ports (not separately shown), to allow the payment services computer 206 to communicate simultaneously with a large number of other devices, including communications as required to simultaneously handle numerous requests for invoice tokens and invoice details

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the payment services computer 206, executed by the processor 300 to cause the payment services computer 206 to function as described herein.

The programs may include one or more conventional operating systems (not shown) that control the processor 300 so as to manage and coordinate activities and sharing of resources in the payment services computer 206, and to serve as a host for application programs (described below) that run on the payment services computer 206.

The programs stored in the storage device 304 may also include a software communications interface 310 that programs the processor 300 to facilitate communications between the payment services computer 206 and e-commerce servers (merchants). In addition, the storage device 304 may store a software communications interface 312 that programs the processor 300 to facilitate communications between the payment services computer 206 and customer devices.

The storage device 304 may also store an invoice token request handling application program 314. The payment credentials request handling application program 314 may program the processor 300 to enable the payment services computer 206 to handle numerous requests from e-commerce servers for invoice tokens, as described herein.

Still further, the storage device 304 may store an invoice details request handling application program 316. The invoice details request handling application program 316 may program the processor 300 to enable the payment services computer 206 to handle numerous requests from customer devices for invoice details, as described herein.

The storage device 304 may also store, and the payment services computer 206 may also execute, other programs, which are not shown. For example, such programs may include a reporting application, which may respond to requests from system administrators for reports on the activities performed by the payment services computer 206. The other programs may also include, e.g., database management software, device drivers, etc.

The storage device 304 may also store an invoice database 318. The invoice database 318 may store invoice details for e-commerce transactions, as uploaded from e-commerce computers to the payment services computer 206. The entries in the invoices database 318 may be indexed by the corresponding invoice tokens generated by the payment services computer 206 for each of the sets of invoice details uploaded to the payment services computer 206.

Further, the storage device 304 may also store one or more additional databases 320 required for operation of the payment services computer 206.

Other computer components of the payment system 200, including e-commerce servers, and computers operated by customers' banks, merchants' banks and the payment network, may have similar hardware architectures and components as those described herein with reference to FIG. 3.

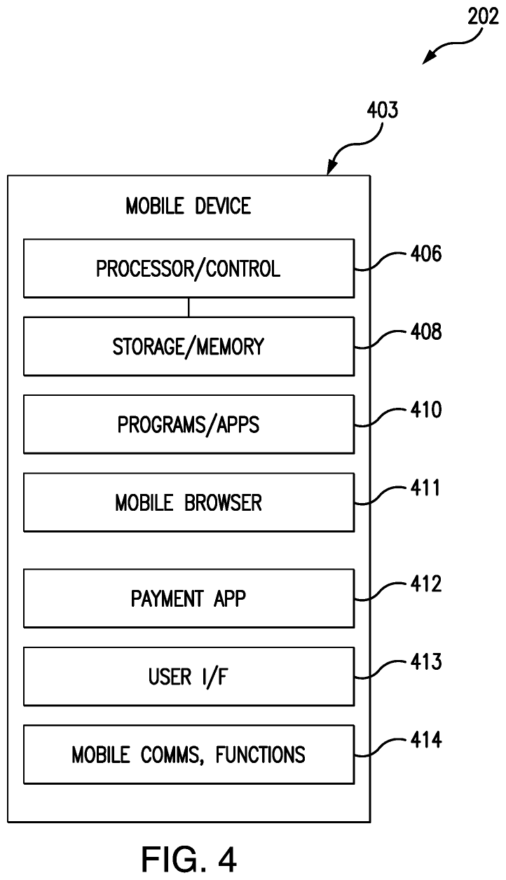

FIG. 4 is a simplified block diagram of an example of the customer device 202 shown in FIG. 2. In this example embodiment, the customer device 202 is illustrated as a mobile device such as a smartphone.

The customer device 202 may include a housing 403. (In cases where the customer device 202 is a desktop computer, the customer device 202 may include several housings including the “tower” housing, the keyboard housing, etc.)

The customer device 202 further includes a processor/control circuit 406, which is contained within the housing 403. Also included in the customer device 202 is a storage/memory device or devices (reference numeral 408). The storage/memory devices 408 are in communication with the processor/control circuit 406 and may contain program instructions to control the processor/control circuit 406 to manage and perform various functions of the customer device 202. Programs/applications (or “apps”) that are stored in the storage/memory devices 408 are represented at block 410 in FIG. 4, and may be accessed to program the processor/control circuit 406. In view of its pertinence to the teachings of this disclosure, a browser program is shown separately from the programs/apps 410 and is represented by block 411. In the same vein, a payment app 412 is depicted separately from the other programs/apps 410.

Physical and/or software aspects of the device user interface, including input/output (I/O) devices, are represented at block 413 in FIG. 4.

As is typical for computing devices, the customer device 202 may include communications components as represented by block 414. The communications components 414 allow the customer device 202 to engage in data communication with other devices. For example, the communications components 414 may support mobile communications functions that include voice and data communications via a mobile communications network (not shown). The data communication capabilities of the customer device 202 may allow for online browsing sessions and interactions with webpages via the browser 411 and/or may support “in-app” communication sessions.

From the foregoing discussion, it will be appreciated that the blocks depicted in FIG. 4 as components of the customer device 202 may in effect overlap with each other, and/or there may be functional connections among the blocks which are not explicitly shown in the drawing.

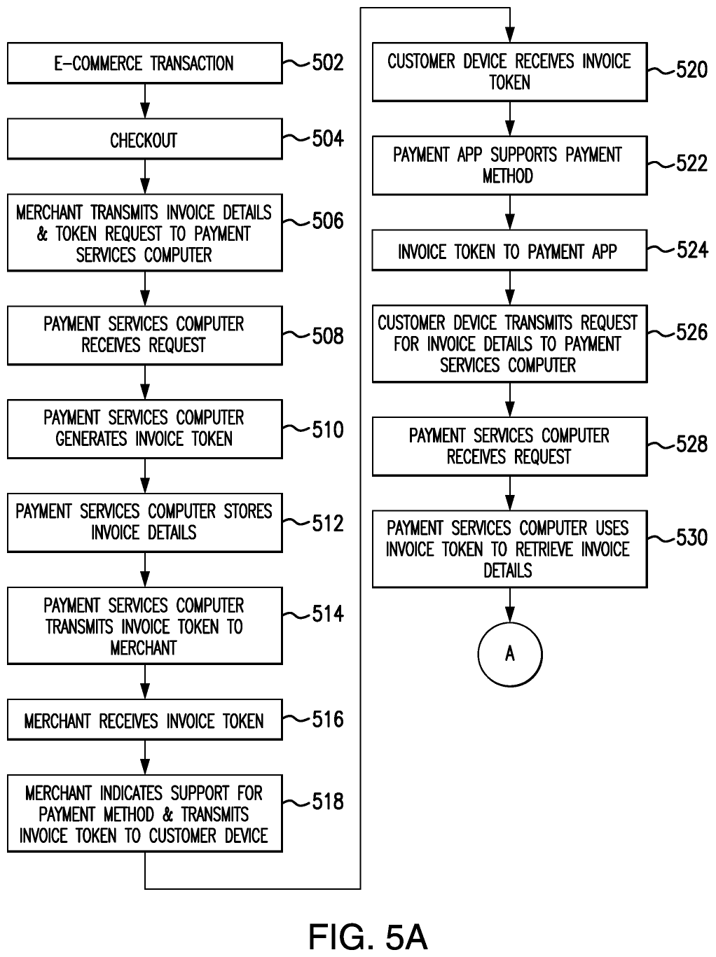

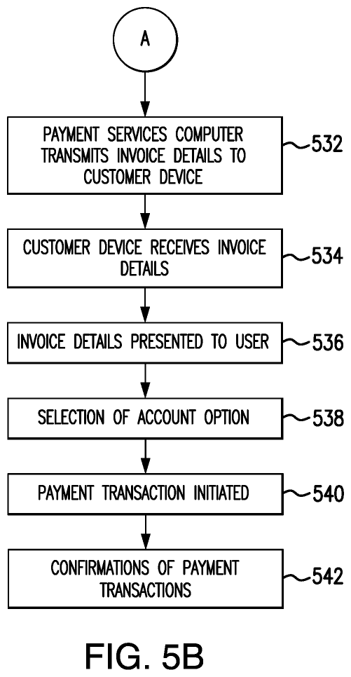

FIGS. 5A and 5B together form a flow chart that illustrates a process that may be performed in the payment system 200 according to aspects of the present disclosure.

Referring initially to FIG. 5A, at 502 the user 103 operates his/her customer device 202/browser 411 to engage in an online shopping transaction via interaction between the browser 411 and the e-commerce server computer 204 (FIG. 2). It is assumed that the user 103 selects one or more items for purchase in the transaction, and proceeds to the checkout phase (block 504) of the online shopping transaction.

At 506, the e-commerce server 204 may transmit a request for an invoice token to the payment services computer 206. The request may include invoice details for the current e-commerce transaction, now in its checkout phase. The invoice details may include the merchant's name, address and other contact information for the merchant. The invoice details may also indicate the merchant's banking information to support the payment transaction that is to come. The banking information may include the routing number and/or other information that identifies the merchant's bank account to which the payment transaction is to be credited. The invoice details may also include transaction details such as transaction date and amount, and a list of the items purchased, possibly including per item pricing data. Applicable sales tax on the transaction may also be indicated in the invoice details. The invoice details may also include the user/customer's name and address.

At 508, the payment services computer 206 may receive the invoice details/invoice token request transmitted at 506. The interchange of data between the payment service computer 206 and the e-commerce server 204 may be suitably secured such that the validity of the purported identity of the e-commerce server is verified and confirmed to satisfy security requirements of the payment services computer 206 and of the payment system 200.

At 510, the payment services computer 206 may generate an invoice token to represent the invoice details received at 508. The invoice token may be an alphanumeric character string, and need not bear any cryptographic or other relationship to the invoice details that it will represent.

At 512, the payment services computer 206 may store the invoice details received at 508 in the invoice database 318 (FIG. 3), using the invoice token generated at 510 as an index for the database entry containing the invoice details stored in this step. At 514 in FIG. 5A, the payment services computer 206 may transmit the invoice token generated at 510 to the e-commerce server 204. At 516, the e-commerce server 204 may receive the invoice token transmitted at 514.

At 518, the e-commerce server 204 may indicate to the customer device 202 that the e-commerce server 204 supports the payment method described herein, and at the same time may transmit the invoice token to the customer device 202. At 520, the customer device 202 (via operation of the mobile browser 411—FIG. 4) may receive the invoice token.

At 522 in FIG. 5A, it is determined that the payment app 412 (FIG. 4) supports the payment method referred to above in connection with step 518. This determination may occur via an interaction between the mobile browser 411 and the payment app 412. At 524, the invoice token is passed from the mobile browser 411 to the payment app 412. (In connection with these two steps, the user 103 may select the payment app from among a number of payment mechanisms supported in the customer device 202.)

At 526, via operation of the payment app 412, the customer device 202 transmits a request for invoice details to the payment services computer 206. The request may include the invoice token passed to the payment app 412 at step 524. At 528, the payment services computer 206 may receive the invoice details request transmitted at 526.

At 530, the payment services computer 206 may retrieve the invoice details that correspond to the invoice token received at 528. That is, the payment services computer 206 may retrieve the invoice details that correspond to the current e-commerce transaction for which the checkout phase was entered at 504.

In the process of FIGS. 5A-5B, block 532 (FIG. 5B) may follow block 530 (FIG. 5A). Referring to FIG. 5B, at 532, the payment services computer 206 may transmit the invoice details to the customer device 202.

Continuing to refer to FIG. 5B, at 534, via operation of the payment app 412, the customer device 202 may receive the invoice details transmitted at 532. At 536, the customer device 202 may display at least some of the invoice details to the user/customer 103 via the user interface 413 (FIG. 4) of the customer device 202. This allows the user 103 to confirm that the invoice details conform to the purchase that the user intends to make in the current e-commerce transaction.

At 538, the user is presented with an opportunity to select from among a number of different accounts belonging to the user, with the selection to indicate which account is to be used for the current transaction. The selected account will support the payment transaction to come (i.e., the payment transaction will be charged to the selected account). In some embodiments, the accounts available for selection may include a deposit account maintained at a bank and belonging to the user. Other account options available for selection may include credit card accounts, debit card accounts, prepaid card accounts, etc. It is further assumed at 538 that the user selects one of the available account options.

At 540, the user 103 may operate the customer device 202 so as to initiate a payment transaction to settle the current e-commerce purchase transaction. This may involve, for example, the customer device 202 presenting a “confirm payment” option to the user 103 via the user interface 413 of the customer device 202, with the user 103 actuating the “confirm payment” option by, e.g., touching a corresponding virtual button displayed on the customer device 202. Doing so may launch an interaction between the payment app 412 and a computer (not shown apart from block 208 in FIG. 2) operated by the customer's bank (represented by block 208). Pursuant to that interaction, the customer's bank 208 may effectuate a payment transaction whereby the transaction amount indicated by the invoice details is transferred from the user's account selected at 538 to the merchant's account identified by the invoice details. The payment transaction may be a “push” transaction in the payment network 110 or an ACH transaction, depending on the nature of the accounts involved. Again depending on the nature of the accounts involved, the payment network 110 or another system component, which is not shown, may bridge the payment transaction from a card account network transaction to an ACH transaction, or from an ACH transaction to a card account network transaction, as circumstances may require.

At 542 in FIG. 5B, suitable confirmation messages are sent out to the parties to indicate that the payment transaction has been performed successfully. The parties receiving the confirmation messages may include the merchant, the payment services computer 206, and the customer.

Referring again to the payment transaction (step 540), in some embodiments, the payment app 412 in the customer device 202 may initiate the payment transaction by interacting with the payment services computer 206 rather than with the customer's bank. The payment services computer 206 may then manage consummation of the payment transaction.

In some embodiments, the invoice token referred to in the description of the process of FIGS. 5A/5B may be “time sensitive” in the sense that the invoice token is only valid, and will only be accepted by the payment services computer 206, for a rather short period of time, say five or ten minutes, after the invoice token was originally issued. It may be anticipated that in practical embodiments, the steps 504-542 may be completed within a few minutes at most, so that the checkout phase of the e-commerce transaction proceeds expeditiously.

As noted above, a process like that shown in FIGS. 5A/5B may provide advantages in terms of data security because the customer's sensitive account information is never provided to the merchant, and so cannot be compromised by a breach of the merchant's data processing systems. Moreover, through suitable confirmatory actions by the payment services computer vis a vis the merchant/e-commerce server, the customer may have assurance that the payment transaction is being directed to a legitimate merchant with whom the customer intends to deal, thereby avoiding or minimizing the risk that the e-commerce website is fraudulent.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card. The terms “payment card system account” and “payment card account” and “payment system account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present disclosure has been set forth in connection with specific exemplary embodiments, it should be understood that various changes, substitutions, and alterations apparent to those skilled in the art can be made to the disclosed embodiments without departing from the spirit and scope of the disclosure as set forth in the appended claims.

1. A method comprising:
receiving, by a user's mobile device, an invoice token from a merchant, the invoice token representing an invoice for an e-commerce transaction;
transmitting, by the mobile device, the invoice token to a payment services computer to request details of the invoice;
receiving, by the mobile device, the requested invoice details from the payment service computer, said invoice details including a list of items purchased;
selecting, by the mobile device, an account to be used to support payment for the e-commerce transaction; and
initiating, by the mobile device, a payment transaction to settle said e-commerce transaction, the payment transaction based on said invoice details and said selected account.

2. The method of claim 1, wherein said selected account is a deposit account maintained at a bank.

3. The method of claim 1, wherein said receiving steps and said transmitting, selecting and initiating steps are performed by operation of a mobile device.

4. The method of claim 3, wherein the initiating step is performed by operation of a payment application program in said mobile device.

5. The method of claim 1, wherein the invoice token was generated by the payment services computer.

6. The method of claim 5, wherein the invoice token is time-sensitive.

7. The method of claim 1, wherein said receiving steps and said transmitting, selecting and initiating steps are performed by operation of a desktop computer.

8. The method of claim 1, wherein said invoice token is an alphanumeric character string.

9. The method of claim 8, wherein said invoice token is a string of numerals.

10. A method comprising:
receiving, by a computer, from a merchant device, a request for an invoice token, the request being a first request and including invoice details for an e-commerce transaction that involves a merchant that operates the merchant device, said invoice details including a list of items purchased in the e-commerce transaction;
storing, by the computer said received invoice details;
generating, by the computer, said invoice token;
transmitting, by the computer, said invoice token to said merchant device;
receiving, by the computer, from a user's mobile device, a second request, said second request for obtaining the stored invoice details, the second request including said invoice token;
retrieving, by the computer, the stored invoice details using the invoice token; and
transmitting, by the computer, to the mobile device, the retrieved invoice details.

11. The method of claim 10, wherein the first request is received from the merchant and the second request is received from the customer.

12. The method of claim 11, wherein the receiving steps, the transmitting steps and the storing, generating and retrieving steps are all performed by a payment services computer.

13. A mobile device comprising:
a processor; and
a memory device in communication with the processor, the memory device storing program instructions, the processor operative with the program instructions to perform functions as follows:
receiving an invoice token from a merchant, the invoice token representing an invoice for an e-commerce transaction;
transmitting the invoice token to a payment services computer to request details of the invoice;
receiving the requested invoice details from the payment service computer, said invoice details including a list of items purchased;
selecting an account to be used to support payment for the e-commerce transaction; and
initiating a payment transaction to settle said e-commerce transaction, the payment transaction based on said invoice details and said selected account.

14. The mobile device of claim 13, wherein said selected account is a deposit account maintained at a bank.

15. The mobile device of claim 13, wherein said memory device and said processor are components of a mobile device.

16. The mobile device of claim 15, wherein the initiating function is performed by operation of a payment application program that runs in the mobile device.

17. The mobile device of claim 13, wherein the invoice token was generated by the payment services computer.

18. The mobile device of claim 17, wherein the invoice token is time-sensitive.

19. The mobile device of claim 13, wherein said memory device and said processor are components of a desktop computer.

20. The mobile device of claim 13, wherein said invoice token is an alphanumeric character string.
